(19) United States
(12) Patent Application Publication
(10) Pub. No.: US 2011/0234677 A1
(43) Pub. Date: Sep. 29, 2011

(54) CORRECTION VALUE ACQUISITION METHOD, CORRECTION VALUE ACQUISITION PROGRAM, AND LIQUID EJECTION RECORDING APPARATUS

(75) Inventors: Michiaki Tokunaga, Shiojiri-shi (JP); Masahiko Yoshida, Shiojiri-shi (JP); Takeshi Yoshida, Shiojiri-shi (JP); Tatsuya Nakano, Shiojiri-shi (JP)

(73) Assignee: Seiko Epson Corporation, Tokyo (JP)

(21) Appl. No.: 13/070,731

(22) Filed: Mar. 24, 2011

(30) Foreign Application Priority Data
Mar. 24, 2010 (JP) 2010-068668

(51) Int. Cl. B41J 29/393

(52) U.S. Cl. 347/19

(57) ABSTRACT

A correction value acquisition method includes: forming parts of a test pattern and a linear scale on a medium of which a length in a predetermined direction is shorter than a length of the test pattern in the predetermined direction; detecting positions of the scales of the linear scale from image data obtained by reading the test pattern and the linear scale; obtaining a read density of the image data; and calculating a correction value based on the read density.

### BACKGROUND

1. Technical Field

The present invention relates to a correction value acquisition method, a correction value acquisition program, and a liquid ejection recording apparatus.

2. Related Art

In general, a printing apparatus performs printing by ejecting a liquid from nozzles and landing liquid droplets (dots) on a medium. When density irregularity (for example, white streaks or black streaks) occurs in a printed image in printing performed by such a printing apparatus, the image quality of the image may deteriorate. As a method of solving this problem, there is known a method of correcting the density of an image based on a density correction value acquired for each dot line (raster line).

As a method of acquiring the density correction value, there was suggested a method of: acquiring image data of a test pattern by reading the test pattern formed on a medium (test sheet or the like) using a scanner; and acquiring a density correction value for each dot line (raster line) based on the image data of the acquired test pattern (for example, see JP-A-2-54676).

The test pattern used to acquire the density correction value is printed using data of a test pattern suitable for a medium with the largest size which can be printed by the printing apparatus. On the other hand, the size of a medium used in printing is different whenever the printing is performed. Therefore, when printing is performed on a medium with a small size using the data of the test pattern for the largest size, the test pattern may not be completely printed in a vertical direction and the printing may be interrupted in some cases.

When the vertical length of the test pattern may not be determined, a vertical deviation between pixel data of the test pattern and an actually printed result may not be corrected, thereby acquiring no exact density correction value. Moreover, it is difficult for a user to generate data of a test pattern suitable for the size of a medium for each case of printing.

### SUMMARY

An advantage of some aspects of the invention is that it provides a technique for printing a test pattern to acquire an exact density correction value without changing data even for a medium with a different size and acquiring the density correction value.

According to an aspect of the invention, there is provided a correction value acquisition method including: forming parts of a test pattern, in which dot lines formed in an intersection direction intersecting a predetermined direction are lined up in the predetermined direction, and a linear scale, in which scales are lined up in the predetermined direction, on a medium of which a length in the predetermined direction is shorter than a length of the test pattern in the predetermined direction using a liquid ejection recording apparatus forming dots on the medium by ejecting a liquid from nozzle lines lined up in the predetermined direction according to the print data used to form the test pattern and the linear scale; detecting positions of the scales of the linear scale from image data obtained by reading the test pattern and the linear scale formed on the medium; obtaining a read density of the image data for each of the dot lines at positions corresponding to the dot lines of the image data in the predetermined direction based on the detected positions of the scales; and calculating a correction value corresponding to each of the dot lines based on the read density corresponding to each of the dot lines.

Other aspects of the invention are apparent by description of the specification and the accompanying drawings.

### BRIEF DESCRIPTION OF THE DRAWINGS

The invention will be described with reference to the accompanying drawings, wherein like numbers reference like elements.

FIG. 1 is a diagram illustrating the outward appearance configuration of a recording system.

FIG. 2 is a block diagram illustrating the configuration of a printer.

FIG. 3A is a schematic sectional view illustrating the configuration of the printer according to an embodiment.

FIG. 3B is a schematic plan view illustrating the configuration of the printer according to the embodiment.

FIG. 4 is a diagram illustrating arrangement of heads of a head unit.

FIG. 5 is a diagram illustrating a printing method performed by the printer according to the embodiment.

FIG. 6A is a schematic sectional view illustrating a scanner.

FIG. 6B is a plan view illustrating the scanner in which its upper cover is removed.

FIG. 7A is a diagram illustrating the form of raster lines when dots are ideally formed.

FIG. 7B is a diagram illustrating the form of raster lines when density irregularity occurs.

FIG. 8 is a flowchart illustrating calculation of correction values according to the related art.

FIG. 9 is a diagram illustrating a test pattern for density correction according to a comparative example.

FIG. 10 is a diagram illustrating a method of correcting an image by a resolution conversion process.

FIG. 11 is a diagram illustrating the result obtained by reading a cyan correction pattern by the scanner.

FIGS. 12A and 12B are diagrams illustrating a specific method of calculating a density irregularity correction value.

FIG. 13 is a diagram illustrating a correction value table for cyan.

FIG. 14 is a diagram illustrating a case where a correction value corresponding to each gray scale value in an x-th line area of cyan is calculated.

FIG. 15 is a diagram illustrating a case how a printed test pattern is changed by a difference in the length of a medium in a Y direction.

FIG. 16 is a flowchart illustrating calculation of a correction value according to the embodiment.

FIG. 17A is a diagram illustrating a test pattern for density correction according to the embodiment.

FIG. 17B is a diagram illustrating an enlarged linear scale of the test pattern according to the embodiment.

FIG. 18 is a graph illustrating an image data indicating the positions of scales of the linear scale.

FIG. 19A is a diagram illustrating the image data before the test pattern is corrected.

FIG. 19B is a diagram illustrating a method of calculating the image data corresponding to a density calculation position.

### DESCRIPTION OF EXEMPLARY EMBODIMENTS

At least the following aspects of the invention are apparent by description of the specification and the accompanying drawings.

According to an aspect of the invention, there is provided a correction value acquisition method including: forming parts of a test pattern, in which dot lines formed in an intersection direction intersecting a predetermined direction are lined up in the predetermined direction, and a linear scale, in which scales are lined up in the predetermined direction, on a medium of which a length in the predetermined direction is shorter than a length of the test pattern in the predetermined direction using a liquid ejection recording apparatus forming dots on the medium by ejecting a liquid from nozzle lines lined up in the predetermined direction according to the print data used to form the test pattern and the linear scale; detecting positions of the scales of the linear scale from image data obtained by reading the test pattern and the linear scale formed on the medium; obtaining a read density of the image data for each of the dot lines at positions corresponding to the dot lines of the image data in the predetermined direction based on the detected positions of the scales; and calculating a correction value corresponding to each of the dot lines based on the read density corresponding to each of the dot lines.

According to the correction value acquisition method, the test pattern by which the exact correction value can be acquired without changing data is printed even for a medium with a different size, and the density correction value can be obtained.

In the correction value acquisition method according to the aspect of the invention, the read density of the image data at each of the positions corresponding to the dot lines of the image data in the predetermined direction may be obtained by segmenting a gap between two adjacent scales of the linear scale into the number of pixels, which is calculated by dividing a read resolution of the image data in the predetermined direction by an interval of the scales of the linear scale in the predetermined direction, and using gray scale values at positions corresponding to the segmented pixels in the predetermined direction in the image data.

According to the correction value acquisition method, the dot lines formed when printing the test pattern and the pixel lines in the image data obtained by reading the test pattern by a scanner can be made to correspond to each other.

In the correction value acquisition method according to the aspect of the invention, a resolution of the image data may be converted so that the actual number of pixels formed between a ruled line printed together with the test pattern in the intersection direction and a predetermined scale among the scales of the linear scale matches with the number of dot lines formed in theory.

According to the correction value acquisition method, the correction value can be acquired as in the related art even when the width of a sheet is small and a lower ruled line is not drawn.

In the correction value acquisition method according to the aspect of the invention, the liquid ejection recording apparatus may include a plurality of nozzle lines ejecting a plurality of different color ink, respectively, and may print the linear scales with different colors and the test patterns for the nozzle lines, respectively.

According to the correction value acquisition method, the more exact correction value can be obtained for each nozzle line by making the test pattern correspond to the linear scale in each of the nozzle lines ejecting different color ink.

According to another aspect of the invention, there is provided a correction value acquisition program which is stored in a memory and acquires a correction value used when densities of dot lines formed in an intersection direction intersecting a predetermined direction with ink ejected from nozzle lines lined up in the predetermined direction are corrected. The correction value acquisition program includes: forming parts of a test pattern, in which dot lines formed in the intersection direction intersecting the predetermined direction are lined up in the predetermined direction, and a linear scale, in which scales are lined up in the predetermined direction, on a medium of which a length in the predetermined direction is shorter than a length of the test pattern in the predetermined direction according to the print data used to form the test pattern and the linear scale; detecting positions of the scales of the linear scale from image data obtained by reading the test pattern and the linear scale formed on the medium; obtaining a read density of the image data for each of the dot lines at positions corresponding to the dot lines of the image data in the predetermined direction based on the detected positions of the scales; and calculating a correction value corresponding to each of the dot lines based on the read density corresponding to each of the dot lines.

According to the correction value acquisition program, the test pattern by which the exact density correction value can be acquired without changing data is printed even for a medium with a different size, and the density correction value can be obtained.

In the correction value acquisition program according to the aspect of the invention, the read density of the image data at each of the positions corresponding to the dot lines of the image data in the predetermined direction may be obtained by segmenting a gap between two adjacent scales of the linear scale into the number of pixels, which is calculated by dividing a read resolution of the image data in the predetermined direction by an interval of the scales of the linear scale in the predetermined direction, and using gray scale values at positions corresponding to the segmented pixels in the predetermined direction in the image data.

According to the correction value acquisition program, the dot lines formed when printing the test pattern and the pixel lines in the image data obtained by reading the test pattern by a scanner can be made to correspond to each other.

In the correction value acquisition program according to the aspect of the invention, the linear scales with different colors and the test patterns may be printed for nozzle lines ejecting a plurality of different color ink, respectively.

According to the correction value acquisition program, the more exact correction value can be obtained for each nozzle line by making the test pattern correspond to the linear scale in each of the nozzle lines ejecting different color ink.

According to still another aspect of the invention, there is provided a liquid ejection recording apparatus including: a head unit including nozzle lines lined up in a predetermined direction and forming dots by ejecting a liquid on a medium; and a controller controlling the head unit. The controller forms parts of a test pattern, in which dot lines formed in an intersection direction intersecting the predetermined direction are lined up in the predetermined direction, and a linear scale, in which scales are lined up in the predetermined direction, on a medium of which a length in the predetermined direction is shorter than a length of the test pattern in the predetermined direction according to print data used to form the test pattern and the linear scale, detects positions of the scales of the linear scale from image data obtained by reading the test pattern and the linear scale formed on the medium, obtains a read density of the image data for each of the dot lines at positions corresponding to the dot lines of the image data in the predetermined direction based on the detected positions of the scales, and calculates a correction value corresponding to each of the dot lines based on the read density corresponding to each of the dot lines.

### Basic Configuration of Recording System

### General Configuration

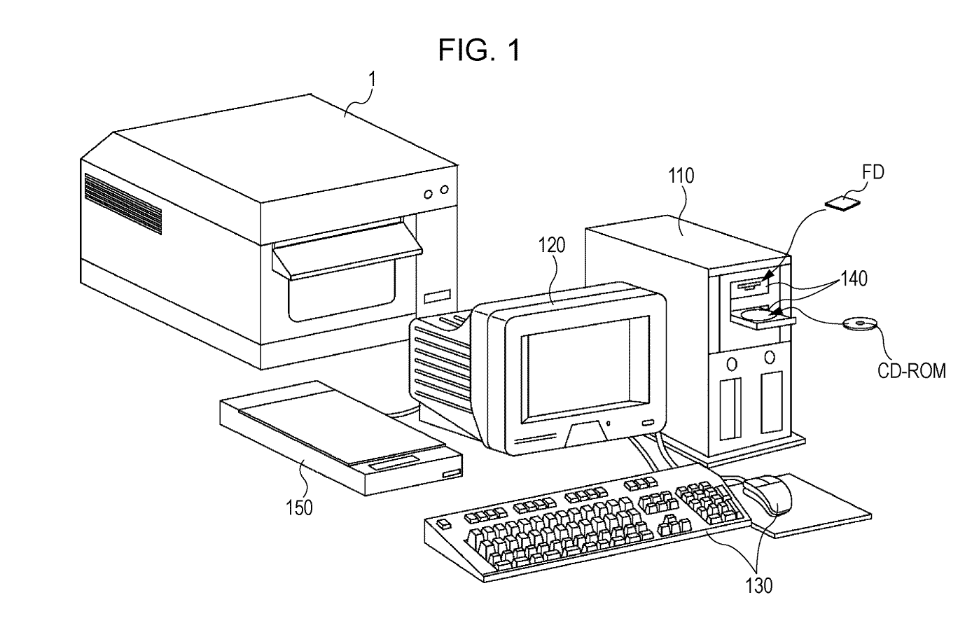

FIG. 1 is a diagram illustrating the outward appearance configuration of a recording system. The recording system according to an embodiment includes a printer 1, a computer 110, a display apparatus 120, an input apparatus 130, a record reproduction apparatus 140, and a scanner 150. The printer 1 is a printing apparatus that records an image on a medium such as a sheet, a cloth, or a film. The computer 110 is connected to the printer 1 in a communicable manner. The computer 110 thus outputs print data corresponding to an image to be printed to the printer 1 to allow the printer 1 to print the image.

A printer driver is installed in the computer 110. The printer driver is a program that displays a user interface on the display apparatus 120 and converts image data output from an application program into print data. The printer driver is recorded in a recording medium (which is a computer-readable recording medium) such as a flexible disk FD or a CD-ROM. The printer driver may be downloaded to the computer 110 via the Internet. The program includes codes implementing various kinds of functions.

### Configuration of Printer 1

As an example of a printing apparatus embodying the invention, an ink jet printer (printer 1) will be described.

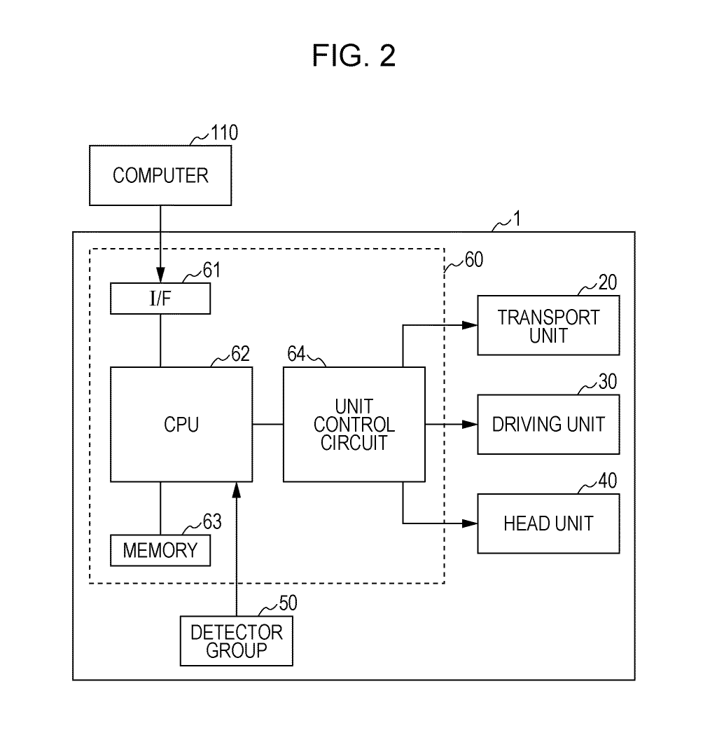

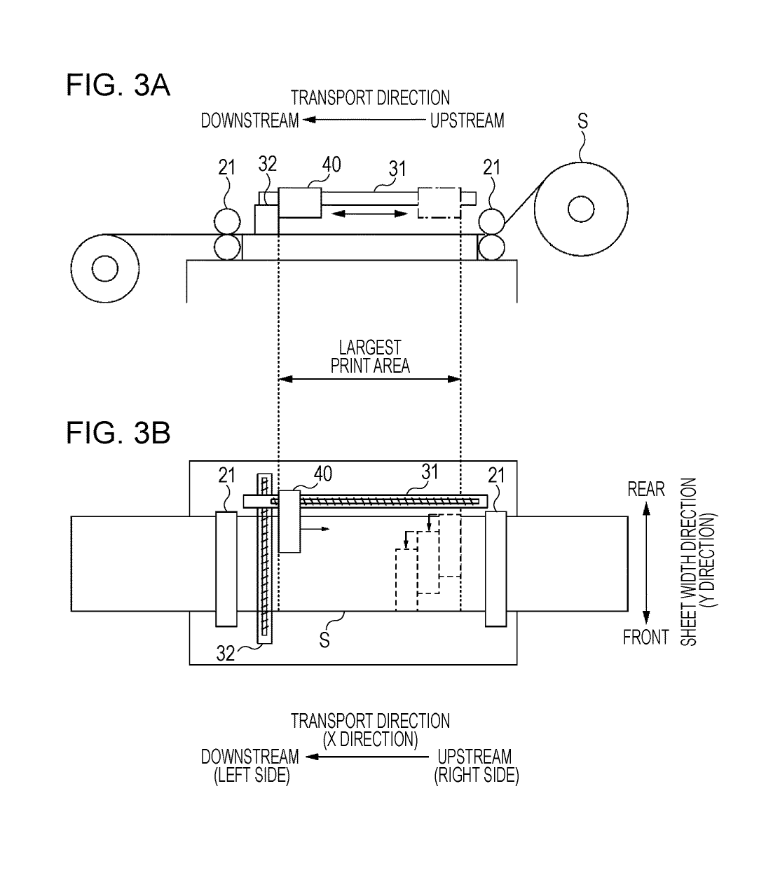

FIG. 2 is a block diagram illustrating the configuration of the printer 1. FIG. 3A is a schematic sectional view illustrating the printer 1. FIG. 3B is a schematic plan view illustrating the printer 1.

The printer 1 includes a transport unit 20, a driving unit 30, a head unit 40, a detector group 50, and a controller 60. The controller 60 controls each unit based on print data received from the computer 110 serving as a printing apparatus control unit, and prints an image on a medium. The detector group 50 detects the situation of the printer 1. The detector group 50 outputs the detection result to the controller 60. The controller 60 controls each unit based on the detection result output from the detector group 50.

### Transport Unit 20

The transport unit 20 transports a medium S (for example, a paper sheet or the like) from the upstream side to the downstream side of a predetermined direction (hereinafter, referred to as a transport direction). The medium S in a roll form before printing is supplied to a print area by a transport roller 21 driven by a transport motor (not shown), and then the printed medium S is wound into a roll form by a winding mechanism, or is cut in an appropriate length and is discharged. The operation of the transport motor is controlled by the controller 60 of the printer 1. In the print area, the medium S is held at a predetermined position by adsorbing the medium S in a vacuum manner from the lower side during printing.

### Driving Unit 30

The driving unit 30 moves the head unit 40 in an X direction corresponding to the transport direction and a Y direction corresponding to a sheet width direction (which is a direction perpendicular to the transport direction) of the medium S. The driving unit 30 includes an X-axis stage 31 moving the head unit 40 in the X direction, a Y-axis stage 32 moving the X-axis stage 31 in the Y direction, and a motor (not shown) moving the X-axis stage 31 and the Y-axis stage 32.

### Head Unit 40

The head unit 40, which forms an image by ejecting ink on the medium S, includes a plurality of heads 41. A plurality of nozzles ejecting ink is formed on the lower surface of the head 41. Each of the nozzles is provided with an ink chamber filled with ink.

The head unit 40 is installed in the X-axis stage 31. Therefore, when the X-axis stage 31 is moved in the X direction (transport direction), the head unit 40 is also moved in the X direction. By intermittently ejecting the ink from the nozzles while the head unit 40 is moved in the X direction (transport direction), dot lines (raster lines) are formed on the medium S in the X direction. Thereafter, the head unit 40 is moved in the Y direction (sheet width direction) by the Y-axis stage 32 through the X-axis stage 31, and then the head unit 40 performs printing while being again moved in the X direction.

Accordingly, an image can be printed on the medium S in the print area by repeating the process of forming the raster lines while the head unit 40 is moved in the X direction and the process of moving the head unit 40 in the Y direction. Many images are formed on the continuous medium S by alternately repeating a process (image formation process) of printing an image on the medium S supplied in the print area and a process (transport process) of supplying a new portion of the medium S in the print area by transporting the medium S in the transport direction by the transport unit 20.

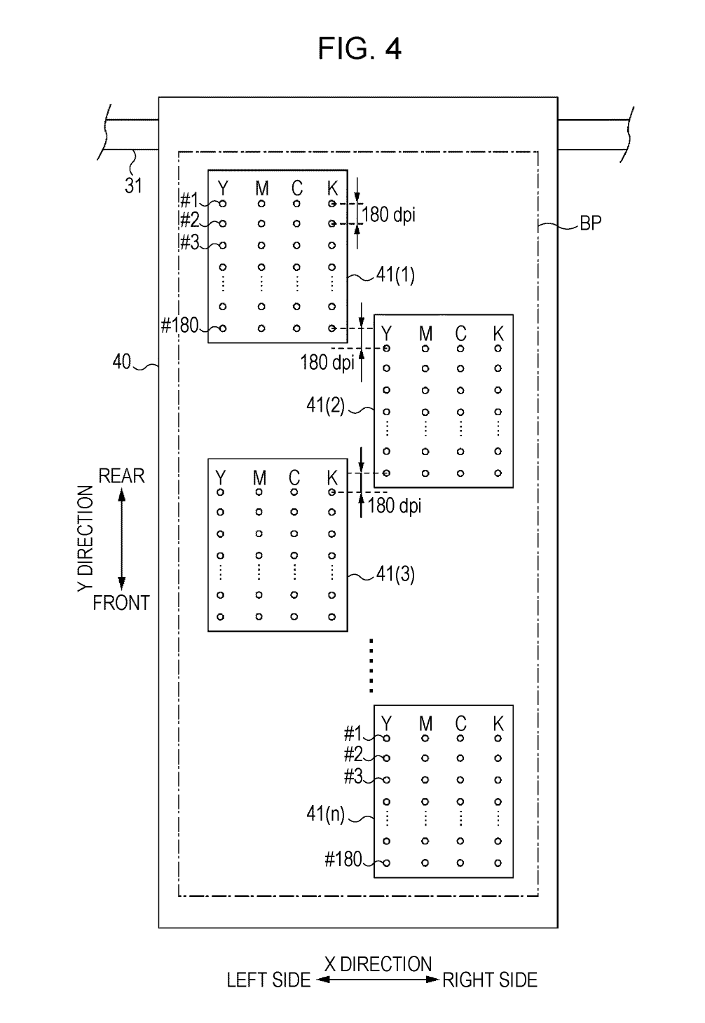

FIG. 4 is a diagram illustrating the arrangement of the plurality of heads 41 of the head unit 40. In effect, the nozzle surface is formed on the lower surface of the head unit 40, but the nozzles are viewed imaginarily from the upper surface in FIG. 4 (the same is applied to the following drawings).

By lining up the plurality of nozzles in the Y direction (sheet width direction), an image with a large width can be printed by moving the head unit 40 once in the X direction (transport direction). By doing so, high speed printing can be achieved. However, a head with a long length may not be formed due to the difficulties in manufacturing. Accordingly, the printer 1 is provided with a plurality of heads 41(1) to 41(n) with a short length which are arranged in parallel in the Y direction. As shown in FIG. 4, the plurality of heads 41 is mounted on a base plate BP.

A black nozzle line K ejecting black ink, a cyan nozzle line C ejecting cyan ink, a magenta nozzle line M ejecting magenta ink, and a yellow nozzle line Y ejecting yellow ink are formed on the nozzle surface of each head 41. Each of the nozzles lines has 180 nozzles, and the 180 nozzles are arranged in the Y direction at a constant nozzle pitch (180 dpi). As illustrated, smaller numbers are sequentially given to nozzles on the rear side of the Y direction (#1 to #180).

An interval between nozzle #180 on the side farthest to the front of the rear head 41(1) between two heads (for example, heads 41(1) and 41(2)) adjacent to each other in the Y direction and nozzle #1 on the side farthest to the rear of the front head 41(2) is also arranged at the constant interval (180 dpi). That is, on the lower surface of the head unit 40, the nozzles are lined up at the constant nozzle pitch (180 dpi) in the Y direction. As shown in FIG. 3, in order to line up the nozzles in the end portions of the different heads 41 at the interval of 180 dpi, it is necessary to arrange the heads 41 in a zigzag shape due to the restriction on the structure of the heads 41. In addition, the nozzles in the end portions of the different heads 41 may overlap with each other.

### Detector Group 50

The detector group 50 includes a rotary encoder or a linear encoder (neither of which are shown). The rotary encoder detects a rotation amount of the transport roller 21 and detects a transport amount of a medium based on the detection result. The linear encoder detects the position of the X-axis stage 31 or the Y-axis stage 32 in the movement direction.

### Controller 60

The controller 60 is a control unit (controller) that controls the printer. The controller 60 includes an interface unit 61, a CPU 62, a memory 63, and a unit control circuit 64 (see FIG. 2).

The interface unit 61 transmits and receives data between the computer 110 as an external apparatus and the printer 1. The CPU 62 is an arithmetic processing unit which controls the entire printer 1. The memory 63 is a unit which ensures an area for storing a program of the CPU 62 and a working area and includes a storage device such as a RAM or an EEPROM. The CPU 62 controls each unit such as the transport unit 20 through the unit control circuit 64 according to a program stored in the memory 63.

### Printing Process of Printer 1

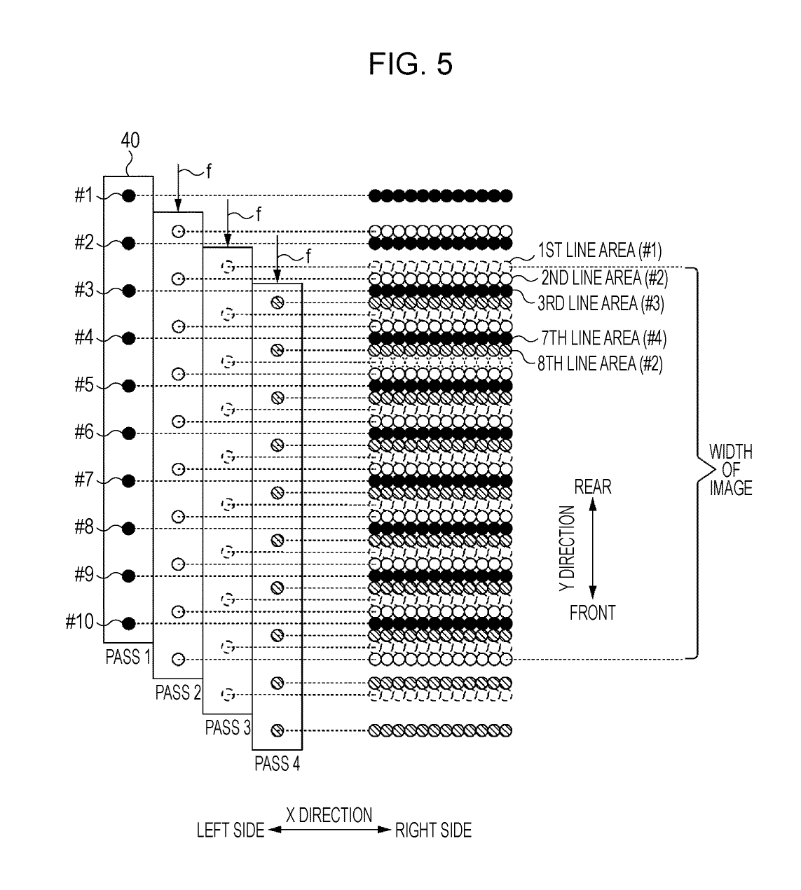

FIG. 5 is a diagram illustrating a printing method performed by the printer 1 according to this embodiment. In order to facilitate a simple description, the number of nozzles lined up in the Y direction (sheet width direction) in the head unit 40 is reduced to ten. A one-time process of forming an image while the head unit 40 is moved in the X direction is referred to as a “pass”. Here, the printer 1 completes an image in four passes, and raster lines by different pass are formed between the raster lines (dot lines in X direction (transport direction)) formed by a given pass. By doing so, an image with high image quality can be printed since a print resolution in the Y direction can be increased further than the nozzle pitch (180 dpi).

More specifically, ten raster lines (black circles) are first formed in pass 1, while the head unit 40 is moved in the X direction. Thereafter, the head unit 40 is moved by a predetermined amount f forward in the Y direction by the Y-axis stage 32. Then, ten raster lines (white circles) are formed in pass 2 while the head unit 40 is moved again in the X direction. At this time, the head unit 40 is moved in the Y direction by the predetermined amount f so that the raster lines formed in pass 2 are formed on the rear side of the raster lines formed in pass 1 in the transport direction. Thus, the image is completed by repeating the process of forming the raster lines while moving the head unit 40 in the X direction and the process of moving the head unit 40 in the Y direction by the predetermined amount f.

In the printing method shown in FIG. 5, there are areas which are not filled between the raster lines on the rear and front sides in the sheet width direction. Therefore, it is assumed that an area where a gap does not occur between the raster lines is an image width which the printer 1 can print in the X direction.

In the following description, a “pixel area” and a “line area” are set. The “pixel area” refers to a rectangular area imaginarily determined on the medium S. The size of the pixel area is determined depending on a print resolution. One “pixel area” on the medium S corresponds to one piece of “pixel data” in the image data. In addition, the “line area” refers to an area including the plurality of pixel areas lined up in the X direction. The “line area” corresponds to “pixel line data” in which the plurality of pixel data in the image data is lined up in a direction corresponding to the X direction.

Smaller numbers are given to the line areas on the rear side in the Y direction. For example, in the printing method shown in FIG. 5, it is assumed that the raster line (dot line) formed by a first nozzle #1 in pass 3 is a raster line formed in a first line area. The raster line formed in a second line area is formed by a second nozzle #2 in pass 2, and the raster line formed in a third line area is formed by a third nozzle #3 in pass 1. The raster line formed in a seventh line area is formed by a fourth nozzle #4 in pass 1, and the raster line formed in an eighth line area is formed by the second nozzle #2 in pass 4. Therefore, in the printing method according to this embodiment, it can be understood that the nozzles forming the raster lines in the adjacent line areas may not be the same nozzles even in the line areas formed by the same second nozzle #2.

### Configuration of Scanner 150

The scanner 150 is an image input unit which reads an image printed by the printer 1 and acquires the image data.

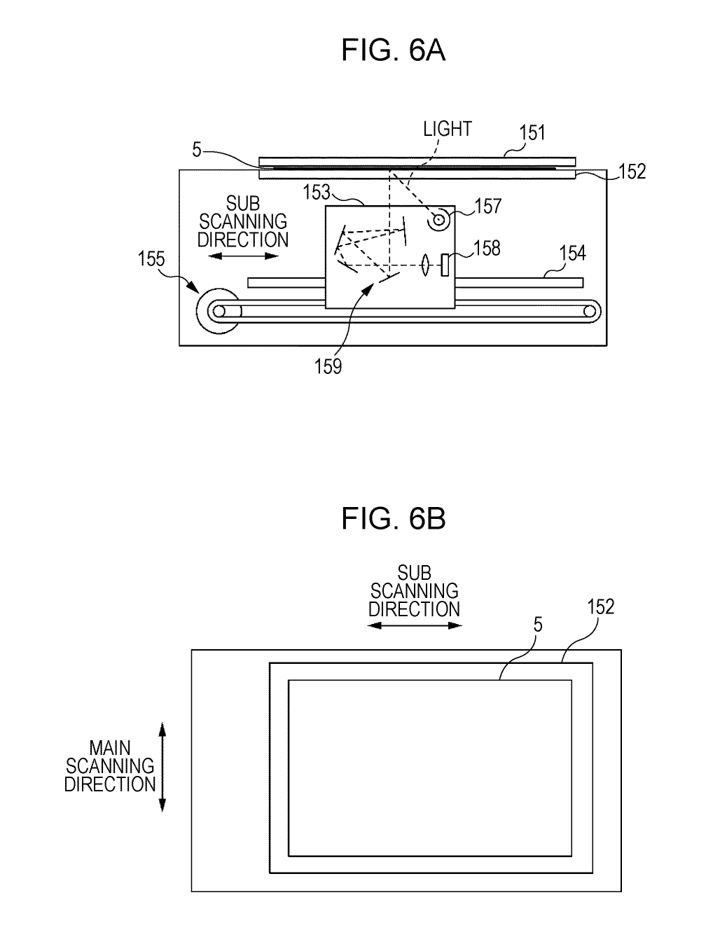

FIG. 6A is a sectional view illustrating the scanner 150. FIG. 6B is a plan view illustrating the scanner 150 in which an upper cover 151 is removed.

The scanner 150 includes: the upper cover 151; a document table glass 152 on which a document 5 (for example, the medium S on which an image is printed by the printer 1) is placed; a reading carriage 153 which is moved in a sub scanning direction as to face the document 5 with the document table glass 152 interposed therebetween; a guide unit 154 which guides the reading carriage 153 in the sub scanning direction; a movement mechanism 155 which moves the reading carriage 153; and a scanner controller (not shown) which controls each unit of the scanner 150. The reading carriage 153 is provided with an exposure lamp 157 emitting light toward the document 5, a line sensor 158 which is an example of a reading unit detecting an image of a line in a main scanning direction (which is a direction perpendicular to the sheet surface of FIG. 6A), and an optical system 159 leading reflected light from the document 5 to the line sensor 158. A broken line inside the reading carriage 153 in the drawing denotes the locus of the light.

### Description of Density Irregularity

### Banding

When printing is performed by an ink jet printer, density irregularity may occur in the formed raster line due to variation of processing precision of the nozzle lines ejecting ink and the like. When such density irregularity occurs, a pattern with a band form seems to be formed (banding) on a printed surface, thereby deteriorating the image quality of a printed image.

Hereinafter, the “density irregularity” will be described. In order to facilitate a simple description, a cause that generates the density irregularity in an image printed with a single color will be described.

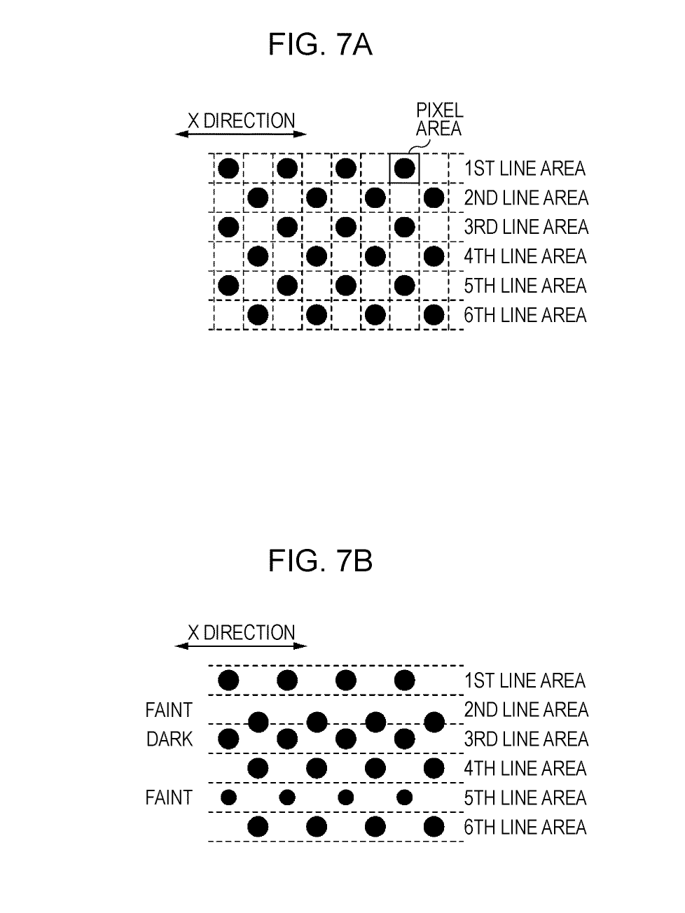

FIG. 7A is a diagram illustrating the form of raster lines when dots are ideally formed (when no density irregularity occurs). In FIG. 7A, since the dots are ideally formed, the dots are formed exactly within the pixel areas demarcated by broken lines and thus the raster lines are formed regularly along the line areas. In each line area, an image piece of the density appropriate for the coloring of the area is formed. Here, in order to facilitate a simple description, it is assumed that an image with a constant density in which a dot formation ratio is 50% is printed.

Next, FIG. 7B is a diagram illustrating the form of raster lines when the density irregularity occurs. In FIG. 7B, the raster line formed in the second line area in FIG. 7A is formed closer to the side of the third line area due to the fact that ink droplets ejected from the nozzles fly at an angle. As a consequence, the density of the second line area becomes faint and the density of the third line area becomes dark. On the other hand, the ink amounts of ink droplets ejected toward the fifth line area are smaller than defined amounts of ink droplets and thus the dots formed in the fifth line area become small. As a consequence, the density of the fifth line area becomes faint.

When an image formed by the line areas with different shadings is viewed macroscopically, the density irregularity banded along the direction (in this embodiment, the X direction) in which the raster lines are formed is viewed. According to this embodiment, there is provided a method of correcting this density irregularity.

### Method of Correcting Density Irregularity

In order to solve the pattern with the band form caused by the density irregularity in regard to the line area where the density is easily viewed as dark, gray scale values indicated by the pixel data corresponding to the line area are corrected so that faint image pieces are formed. In contrast, in regard to the line area where the density is easily viewed as faint, gray scale values indicated by the pixel data corresponding to the line area are corrected so that dark image pieces are formed.

Here, in FIG. 7B, the reason why the density of the image pieces formed in the third line area is dark is not that the density is influenced by the nozzles forming the third line area but is influenced by the nozzles forming the adjacent second line area. Therefore, when the nozzles forming the raster line in the third line area form a raster line in a different line area, the image pieces formed in that line area do not necessarily become dark. As described above, this is because a line area adjacent to a line area assigned to certain nozzles may not necessarily be formed by the same nozzles every time.

That is, even the image pieces formed by the same nozzles may have different densities when the nozzles forming the adjacent raster line are different. In this case, the density irregularity may not be prevented with the correction values merely corresponding to the nozzles. In this embodiment, however, a correction value H of the density irregularity is set in each line area (each pixel line data).

Moreover, since the density irregularity occurs due to a problem such as processing precision of the nozzles, the correction value H for each line area (each pixel line data) is calculated for each printer 1. Hereinafter, a method of calculating the correction value H will be described.

### Method of Calculating Correction Value According to Related Art

First, a method of calculating the correction value H according to the related art will be described as a comparative example.

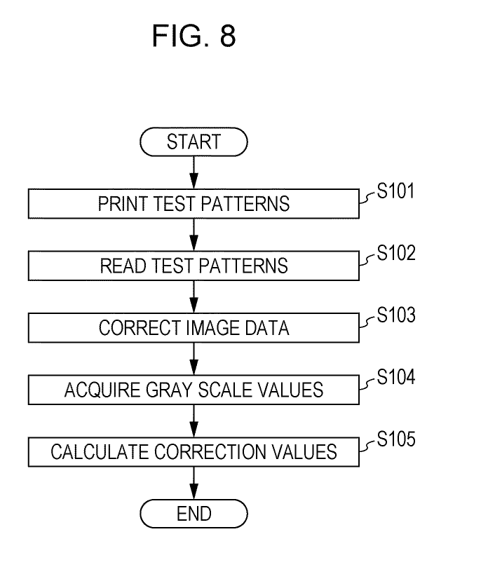

FIG. 8 is a flowchart illustrating the method of calculating the correction value H according to the related art.

The correction value H for each line area is calculated by sequentially executing steps S101 to S105 using the printer 1. The calculated correction value H is stored in the memory 63 of the printer 1. The density correction is performed using the stored correction value H in actual printing. Each step is executed by a correction program installed in the computer 110.

### S101: Printing of Test Pattern

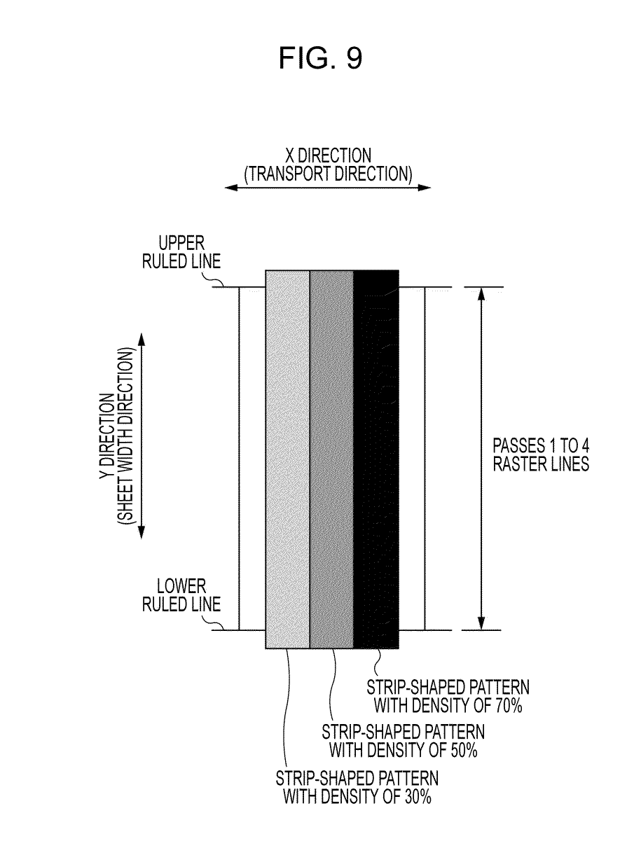

FIG. 9 is a diagram illustrating a test pattern for density correction according to the comparative example. The test pattern includes strip-shaped patterns of three kinds of densities. The strip-shaped patterns are each generated from the image data with a given gray scale value and are each formed by lining up a plurality of dot lines formed in the X direction (transport direction) in the Y direction (sheet width direction).

The gray scale value used for forming the strip-shaped pattern is called an instruction gray scale value. An instruction gray scale value of a strip-shaped pattern with density of 30% is denoted by Sa(76), an instruction gray scale value of a strip-shaped pattern with density of 50% is denoted by Sb(128), and an instruction gray scale value of a strip-shaped pattern with density of 70% is denoted by Sc(179). A higher gray scale value indicates darker density and a lower gray scale value indicates a fainter density.

One strip-shaped pattern includes raster lines formed in four passes by the nozzles of the head unit 40 in the printing method shown in FIG. 5. In addition, since the correction value H corresponding to each of the colors (black, magenta, cyan, and yellow) is calculated, the correction pattern is formed for each color.

A ruled lines is formed in the X direction (transport direction) in each of the upper and lower portions of the test pattern. The upper and lower ruled lines are used when a resolution is converted in correction of the image data (S103) described below. The upper and lower ruled lines serve as reference positions when the number of pixels of the test pattern in the Y direction (sheet width direction) is adjusted. By ensuring the horizontality of the upper and lower ruled lines, the slope can be corrected in a case where the test pattern is tilted when reading an image.

### S102: Reading Test Pattern

The printed test pattern is set in the scanner 150 by a person performing a test. The computer 110 allows the scanner 150 to read the test pattern and acquires the test pattern as image data. In the reading of the test pattern, the image data are acquired by reading the lines in the main scanning direction using the line sensor 158 while moving the line sensor 158 of the scanner 150 in the sub scanning direction.

At this time, the read resolution is 2880 dpi (X direction)×2880 dpi (Y direction), and the image data is formed by pixel data of pixels lined up two-dimensionally in the X and Y directions. Each pixel data forming the image data has a gray scale value of 256 gray scales.

### S103: Correcting Image Data

In the reading of the test pattern (S102), the length corresponding to each pixel in the Y direction may be longer or shorter when there is an error in the read position of the scanner 150. The image of the test pattern indicated by the image data may become an image distorted in the Y direction due to the error in the read position. Accordingly, the distortion in the image is corrected.

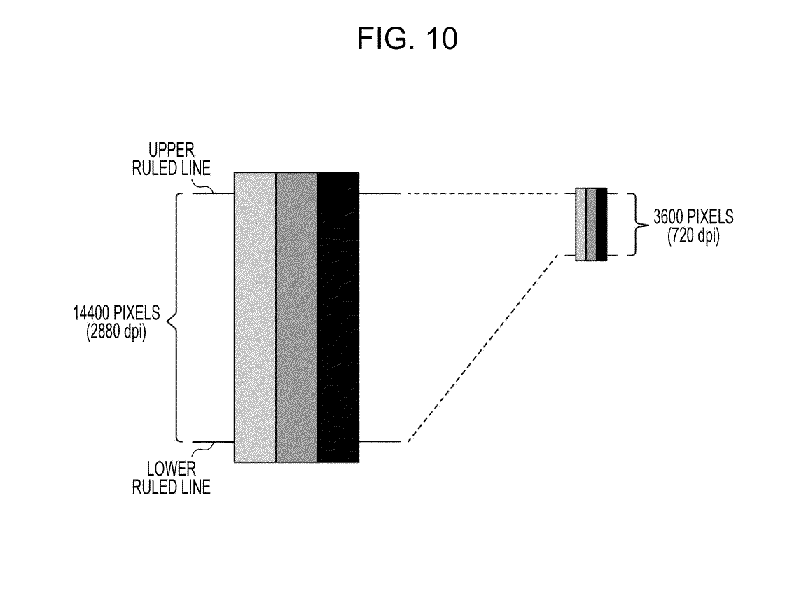

FIG. 10 is a diagram illustrating correction of an image by a resolution conversion process.

In the printing method according to this embodiment, it is assumed that 3600 raster lines (image with an image width corresponding to 3600 lines) are formed in four passes. In FIG. 10, when ruled lines are formed between the upper and lower ruled lines of the test pattern so that 3600 raster lines are formed at 720 dpi and the scanner 150 ideally reads the test pattern with a 2880 dpi resolution (resolution which is four times the test pattern), the number of pixels of the image data in the Y direction is 14400 (=3600×4). In effect, however, the number of pixels of the image data in the Y direction is less than 14400 in some cases due to the influence of deviation during the printing or the reading. Here, it is assumed that the number of pixels between the upper and lower ruled lines (Y direction) of the image data is 14420.

The correction program of the computer 110 performs the resolution conversion (reduction process) on the image data at a ratio of 3600/14420 (=[number of raster lines forming the test pattern]/[number of pixels between the upper and lower ruled lines of the image data in the Y direction]). Thus, the number of pixels of the image data in the Y direction subjected to the resolution conversion is 3600. In other words, the image data of a test pattern with 2880 dpi is converted into the image data of a test pattern with 720 dpi.

As a consequence, since the number of line areas is the same as the number of pixels lined up in the Y direction, the line areas and the pixel lines in the Y direction correspond to each other one to one. For example, the pixel line located at the uppermost position in the Y direction corresponds to the first line area, and the pixel line located at the position immediately lower than the uppermost position corresponds to the second line area. Since the number of pixels in the Y direction is intended to be 3600 in this resolution conversion, the resolution conversion (reduction process) in the X direction may not be performed.

### S104: Acquiring Gray Scale Value

After the distortion of the image data is corrected, a read gray scale value of each line area is acquired for the data.

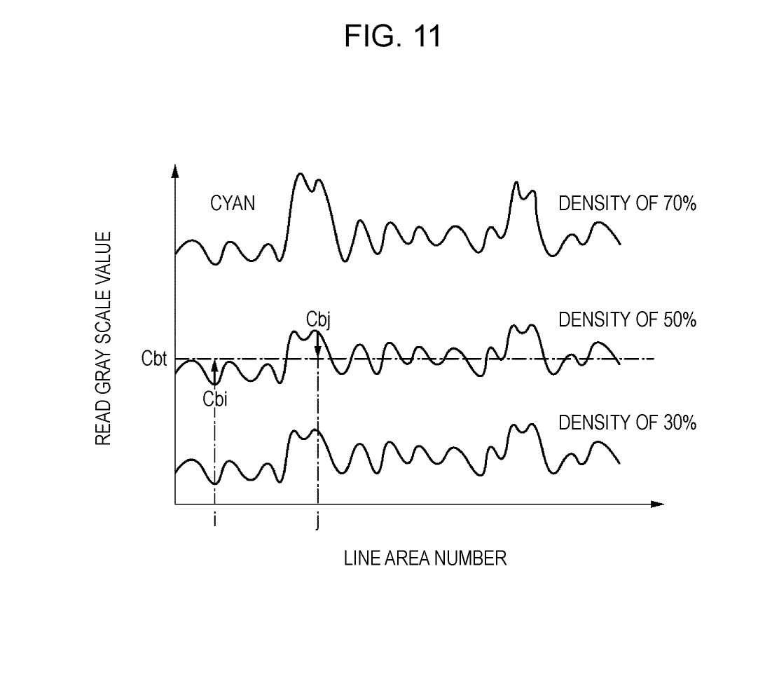

FIG. 11 is a diagram illustrating the result obtained by reading a cyan correction pattern by the scanner 150. In the graph of FIG. 11, the horizontal axis represents a line area number and the vertical axis represents a read gray scale value of each line area.

Hereinafter, the read result of cyan shown in FIG. 11 will be described as an example. After the read gray scale value of the correction pattern is acquired for each color, the pixel line data (a plurality of reading pixels lined up in a direction corresponding to the X direction on the data) in the data read by the scanner 150 is made correspond one to one with one line area (raster line) for the correction pattern. Thereafter, the density of each line area is calculated for each strip-shaped pattern. It is assumed that the average value of the read gray scale values of the respective pixel data belonging to the pixel line data corresponding to a given line area is the read gray scale value of the given line area.

In each strip-shaped pattern, variation in the read gray scale values occurs in each line area irrespective of the strip-shaped pattern being uniformly formed with the instruction gray scale values, as show in FIG. 11. For example, in the graph of FIG. 11, a read gray scale value Cbi of an i line area is lower than the read gray scale values of the other line areas, and a read gray scale value Cbj of a j line area is higher than the read gray scale values of the other line areas. That is, the i line area is viewed as faint and the j line area is viewed as dark. The variation in the read gray scale values in the respective line areas is the density irregularity in a printed image.

### S105: Calculating Correction Value H

The variation in the read gray scale values in the respective line areas is reduced in order to resolve the density irregularity. That is, the read gray scale value of each line area approaches a constant value. Accordingly, an average value Cbt of the read gray scale values of all the line areas is set as a “target value Cbt” for the same instruction gray scale value (for example, Sb with the density of 50%). In addition, the gray scale value indicated by the pixel line data corresponding to each line area is corrected so that the read gray scale value of each line area approaches the target value Cbt in the instruction gray scale value Sb.

Specifically, the gray scale value indicated by the pixel line data corresponding to the i line area with the read gray scale value lower than the target value Cbt in FIG. 11 is corrected to a gray scale value darker than the instruction gray scale value Sb. On the other hand, the gray scale value indicated by the pixel line data corresponding to the j line area with the read gray scale value higher than the target value Cbt is corrected to a gray scale value fainter than the instruction gray scale value Sb. Thus, the correction value H used for correcting the gray scale value of the pixel line data corresponding to each line area is calculated so that the density of all the line areas approaches a constant value for the same gray scale value.

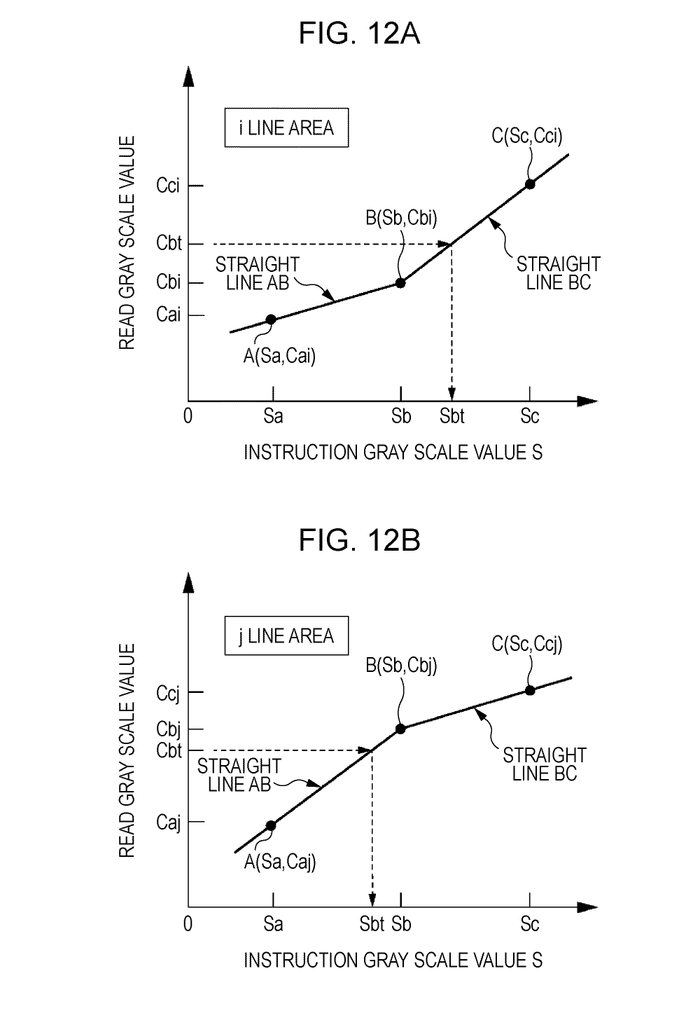

FIGS. 12A and 12B are diagrams illustrating a specific method of calculating the correction value H for the density irregularity. In FIG. 12A, a target instruction gray scale value (for example, Sbt) for the instruction gray scale value (for example, Sb) is calculated for the i line area with the read gray scale value lower than the target value Cbt. The horizontal axis represents a gray scale value and the vertical axis represents the read gray scale value of the test pattern result. In the graph, read gray scale values (Cai, Cbi, and Cci) are plotted for the instruction gray scale values (Sa, Sb, and Sc). For example, the target instruction gray scale value Sbt for the instruction gray scale value Sb is calculated by the following expression (linear interpolation based on a straight line BC) so that the i line area is indicated with the target value Cbt.

Sbt=Sb+{(Sc−Sb)×(Cbt−Cbi)/(Cci−Cbi)}

In the same manner, in the j line area with the read gray scale value higher than the target value Cbt, as shown in FIG. 12B, the target instruction gray scale value Sbt for the instruction gray scale value Sb is calculated by the following expression (linear interpolation based on the straight line AB) so that the j line area is indicated with the target value Cbt.

Sbt=Sa+{(Sb−Sa)×(Cbt−Caj)/(Cbj−Caj)}

Thus, the target instruction gray scale value Sbt for the instruction gray scale value Sb in each line area is calculated. By the following expression, a cyan correction value Hb for the instruction gray sale value Sb of each line area is calculated. Likewise, correction values Ha and Hc for the other instruction gray scale values (Sa and Sc) and correction values for the other colors are calculated.

Hb=(Sbt−Sb)/Sb

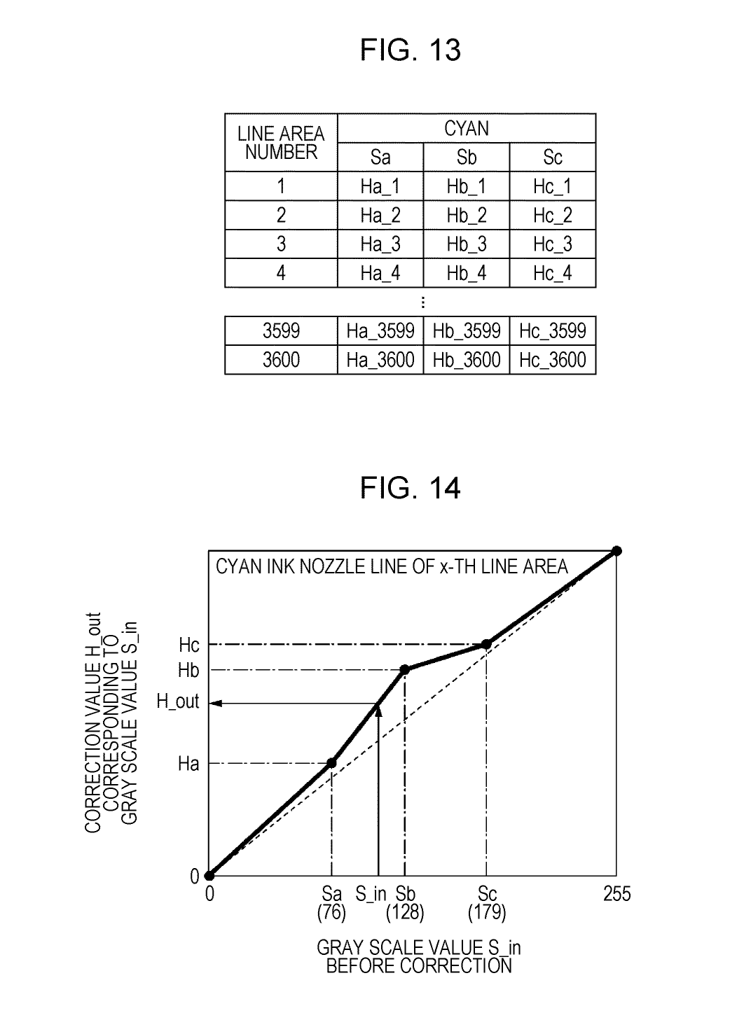

FIG. 13 is a diagram illustrating a correction value table for cyan. In the printing method according to this embodiment, it is assumed that 3600 raster lines (an image with an image width corresponding to 3600 lines) are formed in four passes, as described above. Accordingly, the correction value H is calculated for each of the 3600 line areas where the raster lines are formed in four passes. The correction values H from first to 3600th line areas are set in the correction value table shown in FIG. 13. Such a correction value table is generated for the other colors. In this way, the correction patterns used to calculate the correction values H in the table are stored in the memory 63 of the printer 1 performing the printing.

### Density Correction Process

In order to performing actual printing, the printer driver asks the printer 1 to transmit the correction values H stored in the memory 63 to the computer 110. The printer driver stores the correction values H transmitted from the printer 1 in an internal memory of the computer 110.

FIG. 14 is a diagram illustrating a case where the correction value H corresponding to each gray scale value in an x-th line area of cyan is calculated. It is assumed that the horizontal axis is a gray scale value S_in before correction and the vertical axis is a correction value H_out corresponding to the gray scale value S_in before correction. The printer driver installed in the computer 110 generates print data when receiving a print command from a user, and transmits the print data to the printer 1. The printer driver first converts the resolution of the image data into a resolution corresponding to the print resolution when receiving both the print command from the user and the image data from various kinds of application software, and performs color conversion according to the YMCK colors of the ink of the printer 1.

The printer driver performs the density correction on the data with 256 gray scales for each color of YMCK using the correction values H. That is, the gray scale values (gray scale values S_in before correction) of 256 gray scales of the respective pixel data forming the image data are corrected using the correction values H set for the respective colors and for the respective line areas corresponding to the pixel data.

When the gray scale value S_in before correction is the same as any one of the instruction gray scale values Sa, Sb, and Sc, the gray scale value is the correction value H corresponding to each instruction gray scale value and the correction values Ha, Hb, and Hc stored in the memory of the computer 110 can be used without any change. For example, when the gray scale value S_in before correction is equal to Sc, the grays scale value S_out after correction is calculated by the following expression.

S_out=Sc×(1+Hc)

When the gray scale value S_in before correction is different from the instruction gray scale value, the correction value H_out corresponding to the gray scale value S_before correction is calculated. For example, when the gray scale value S_in before correction is between the instruction gray scale values Sa and Sb, as shown in FIG. 14, the correction value H_out is calculated by linear interpolation of the correction value Ha of the instruction gray scale value Sa and the correction value Hb of the instruction gray scale value Sb by the following expression, and the gray scale value S_out after correction is calculated.

H_out=Ha+{(Hb−Ha)×(S_in−Sa)/(Sb−Sa)}

S_out=S_in×(1+H_out)

When the gray scale value S_in before correction is smaller than the instruction gray scale value Sa, the correction value H_out is calculated by linear interposition of the smallest gray scale value 0 and the instruction gray scale value Sa. When the gray scale value S_in before correction is greater than the instruction gray scale value Sc, the correction value H_out is calculated by linear interposition of the largest gray scale value 255 and the instruction gray scale value Sc.

The gray scale value S_in indicated by the pixel data of 256 gray scales is corrected by the correction value H set for each color, each line area to which the pixel data belongs to, and each gray scale value. Thus, the gray scale value S_in of the pixel data corresponding to the line area where the density is viewed as faint is corrected to the dark gray scale value S_. The gray scale value S_of the pixel data corresponding to the line area where the density is viewed as dark is corrected to the faint gray scale value S_out. As a consequence, the density irregularity occurring in a printed image can be reduced.

The printer driver converts the pixel data (S_out) of 256 gray scales after correction into pixel data of 4 gray scales corresponding to the types of dots which can be formed by the printer 1 by a halftone process. For example, in a printer capable of forming three types of dots (which are a large dot, a middle dot, and a small dot), 8-bit data of 256 gray scales is converted into 2-bit data of 4 gray scales by a halftone process. For example, pixel data indicating “formation of a large dot” is converted into “11”, pixel data indicating “formation of a middle dot” is converted into “10”, pixel data indicating “formation of a small dot” is converted into “01”, and pixel data indicating formation of “no dot” is converted into “00”.

Finally, the image data with a matrix form subjected to the halftone process are rearranged for each data to be transmitted to the printer 1 by rasterization processing, and are transmitted as print data together with command data to the printer 1. When receiving the print data, the printer 1 performs printing based on the print data.

### Problems of Method According to Related Art

As described above, the density irregularity of the band form occurring in a printed image can be reduced by printing a test pattern, calculating the correction value H for each line area, and correcting the density based on the correction value H when performing printing.

On the other hand, this method may not be applied depending on the size of a medium used in the printing in some cases. For example, when the length in a medium width direction (which is the above-described Y direction) is shorter than the length of the test pattern in the Y direction, the exact correction value H may not be acquired.

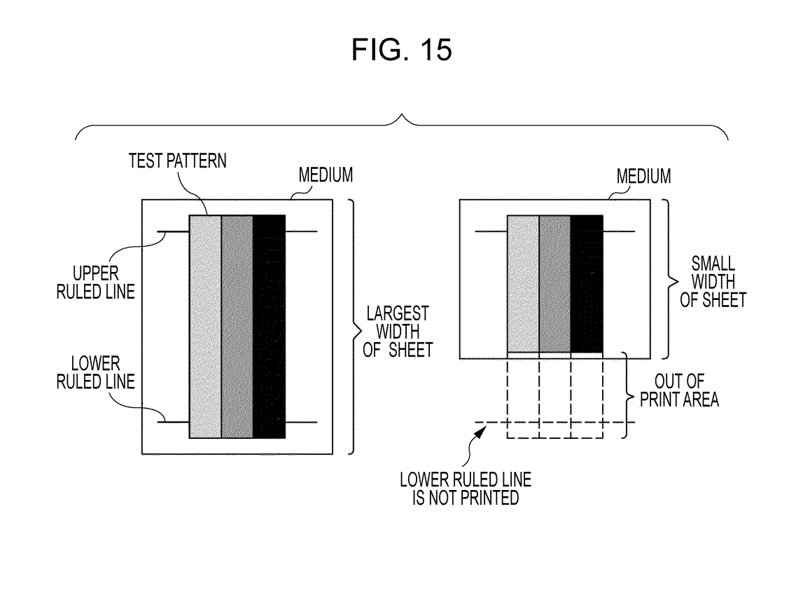

FIG. 15 is a diagram illustrating how a test pattern printed on the medium is changed by the difference in the length of the medium in the Y direction. The print data used to form the above-described test pattern is generated so that the length of the medium likely to be used in the printing in the Y direction is the largest. Therefore, when the print medium has the largest size, the entire test pattern is printed as shown in the left side of FIG. 15. On the other hand, when the length of the medium in the Y direction is short, the lower portion (or/and the upper portion) of the test pattern is outside of the print area, as shown in the right side of FIG. 15. Therefore, the test pattern is printed in a cut state. Since the lower portion (upper portion) of the test pattern is cut off, the lower ruled line (upper ruled line) is not also printed. In this case, the number of raster lines formed in the Y direction (medium width direction) is not specified, and thus the distortion of the image data described above in step S103 may be not corrected. This is because the interval between the upper and lower ruled lines serving as the reference when the number of raster lines is counted is not clear.

Even when the correction value H is calculated in the state where the distortion of the image data is not corrected, a problem may arise in that the correction value H is calculated at the position deviated from the line area where the correction is necessary. That is, the exact correction value used to correct the density irregularity may not be acquired for the line area where the correction is necessary.

The printer 1 according to this embodiment performs the printing by ejecting ink on the medium being transported in the direction (X direction) intersecting the nozzle line from the nozzle lines lined up in the medium width direction (Y direction), as shown in FIG. 5. In such a printing method, the nozzles forming the raster line at a predetermined position in the medium width direction are different in every printing. Therefore, when the width of the medium used in the printing is changed, it is necessary to perform the density correction according to the width of the medium. That is, when the printing is performed using another medium, it is necessary to print the test pattern in which the upper and lower ruled lines are solidly formed in the medium width direction.

However, the technological expertise is necessary in order to generate the test pattern, preparing the appropriate test pattern for each printing by the user is not realistic. Moreover, the widths of media used in the printing by the user are diverse, and thus it is difficult to preset print data for a large variety of test patterns according to the various widths of media in the printer 1 and to ship the printer 1.

### Method of Calculating Correction Value According to Embodiment

In this embodiment, the above-described problems are resolved by calculating exact correction values for the media with different widths using one kind of test pattern.

In the correction value acquisition method according to the related art, the change in the width of a medium may not be sufficiently achieved since the upper and lower ruled lines of a test pattern have to be necessarily printed when printing the test pattern. In regard to this, in this embodiment, the linear scale is printed together with the test pattern. When the printed test pattern is read by a scanner or the like and the image data is generated, the distortion of the image data can be corrected by setting an interval between the scales of a linear scale read together with the test pattern as a reference.

That is, when one kind of test pattern data is prepared for a case where the length of a medium in the medium width direction is the largest, a test pattern can be generated using the data and the exact correction value H can be calculated even in a case where the width of the medium used in the printing is short.

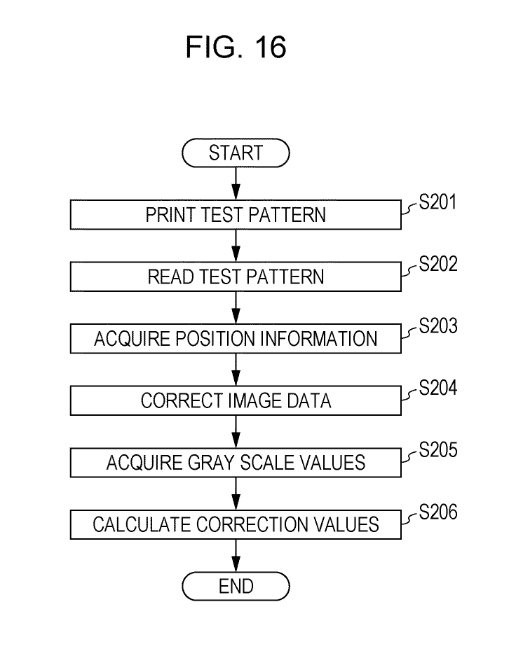

FIG. 16 is a flowchart illustrating calculation of the correction value H according to this embodiment.

The general flow (S201 to S206) is almost the same as the flow (S101 to S105) in the method according to the related art, but is different therefrom in that a test pattern and a linear scale are printed together (S201). In addition, a step (S203) of acquiring position information regarding the linear scale or a method (S203) of correcting the image data is different from those according to the related art.

Hereinafter, the respective steps will be described. The respective steps are implemented by a correction program installed in the computer 110.

### S201: Printing Test Pattern

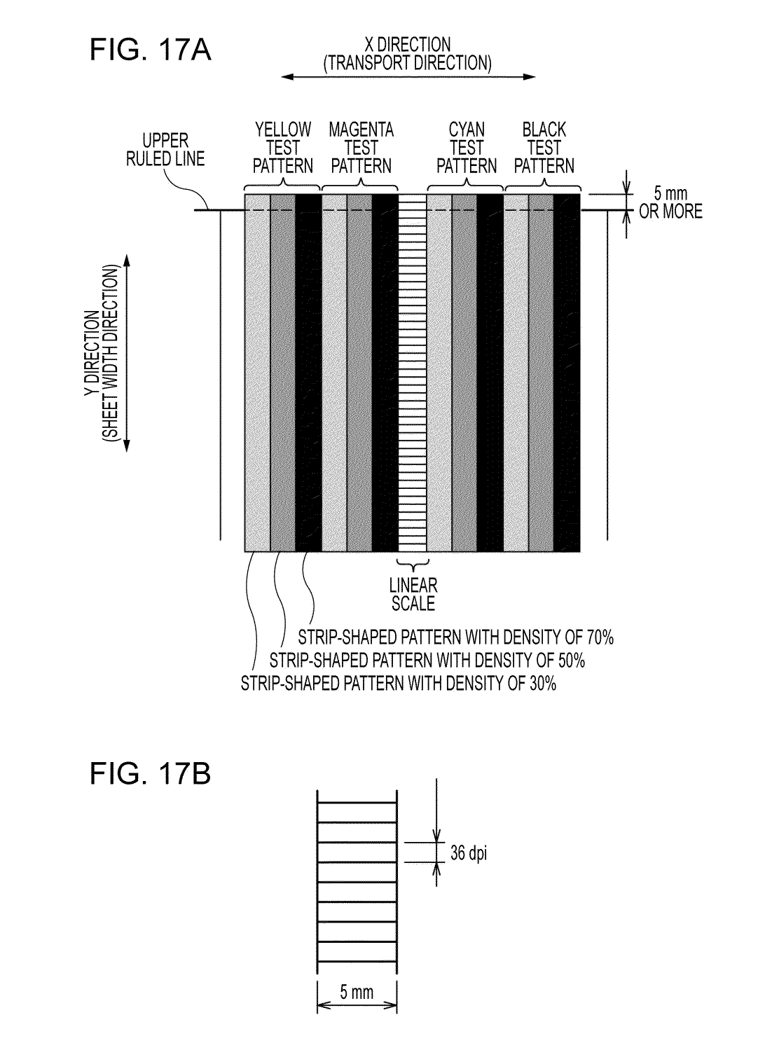

FIG. 17A is a diagram illustrating a test pattern for density correction according to this embodiment. FIG. 17B is a diagram illustrating an enlarged linear scale of the test pattern.

As for the test patterns according to this embodiment, as shown in FIG. 17A, two or more test patterns (in this embodiment, four test patterns are used and the colors of the test patterns are yellow, magenta, cyan, and black) with mutually different colors are formed so that the four test patterns are lined up in the X direction (transport direction) (in this embodiment, yellow, magenta, cyan, and black test patterns are lined up sequentially from the left side to the right side). The test pattern with each color is the same as that described with reference to FIG. 9 and includes strip-shaped patterns formed with three kinds of instruction gray scale values (an instruction gray scale value of a strip-shaped pattern with density of 30% is denoted by Sa(76), an instruction gray scale value of a strip-shaped pattern with density of 50% is denoted by Sb(128), and an instruction gray scale value of a strip-shaped pattern with density of 70% is denoted by Sc(179)).

A linear scale with scales lined up in the Y direction (medium width direction) at a constant interval is formed to be located between the two test patterns (yellow and magenta test patterns) and the two test patterns (cyan and black test patterns). That is, the linear scale is formed at the center position of the test patterns in the X direction.

The movement characteristics of a head may sometimes be different in the forward movement and the backward movement when printing is performed by ejecting ink while the head 40 reciprocates in the X direction (transport direction). Therefore, when the linear scale is formed in the X direction (transport direction) on the upstream side or the downstream side, a difference may occur in the printed linear scale in the Y direction or the linear scale itself may be printed in an inclined manner. Accordingly, by printing the linear scale in the middle portion of the test patterns, printing deviation caused in the process of the head is prevented.

The scales (which are also the raster lines) of the linear scale are printed so that the plurality of scales is lined up in the Y direction at 36 dpi, as shown in FIG. 17B. In the drawing, the scales are drawn at a large interval for description.

The width (length in the X direction) of the linear scale is about 5 mm. This length is the minimum length so that the positions of the scales are not incorrectly detected due to the influence of deviation, dust, or noise occurring in an image read by the scanner 150 when the positions of the scales of the linear scale are detected on the image data in a step (S203) of correcting the image data described below.

The color of ink forming in the linear scale is not particularly limited. In this embodiment, black ink with the highest density is used in consideration of the black ink being good for visibility of the scales of the linear scale when the image data is read. However, experiment ink or the like for printing the linear scale may be used.

The linear scales may be formed with all of the colors of ink (in this embodiment, four yellow, magenta, cyan, and black colors) used to form the test patterns. In this case, each linear scale and each test pattern are printed by each head ejecting each color ink. That is, since the linear scale indicating the reference position in the step (S204) of correcting the image data described below and the test pattern to be corrected can be formed using the same head, an error occurring when specifying the line area where the density correction is necessary can be reduced. Thus, the density correction can be performed with more precision compared to a case where the correction is performed by another color head using the linear scale formed by the black ink head.

As described above, it is not necessary to form the lower ruled line since the linear scale is formed in the test pattern according to this embodiment. On the other hand, the upper ruled line is formed as in the related art. This is because the upper ruled line is used to determine a measurement reference position (the uppermost portion in the Y direction) of the test pattern. Therefore, the upper ruled line is formed to be aligned at the position of the scale of the linear scale so that a difference does not occur between the position of the upper ruled line in the Y direction and the scale position of the linear scale.

However, the formed position of the upper ruled line is set to be located lower than the upper end portion of the test pattern in the Y direction by about 5 mm (see FIG. 17A). In the printer 1 according to this embodiment, the area corresponding to 3 mm from the outer edge portion of a medium is a margin area. Since this area is not subjected to printing, the position at which the upper end portion of the test pattern can be printed is the position of 3 mm from the upper end portion of the medium. When the formed position of the upper ruled line is aligned with the upper end portion of the test pattern, the upper ruled line is printed at the position of 3 mm from the upper end portion of the medium. In this case, in the subsequent step (S202) of reading the test pattern, the upper ruled line may not sometimes be drawn on the acquired image data due to a slight position difference or the like when the test pattern is set in the scanner 150. Accordingly, the upper ruled line is formed at the position (which is a position lower by about 5 mm from the upper end portion of the test pattern) at which the upper ruled line is reliably drawn when the image is read.

### S202: Reading Test Pattern

As described in S102, likewise, the printed test pattern is read by the scanner 150 and is acquired as the image data. At this time, the read resolution is 2880 dpi (X direction)×2880 dpi (Y direction), and the image data include pixel data of pixels lined up two-dimensionally in the X direction and the Y direction. In addition, each of the pixel data of the image data has the gray scale value of 256 gray scales.

An image can also be read by using not only the scanner 150 but also another unit such as a digital camera as a unit acquiring the image.

### S203: Acquiring Position Information Regarding Linear Scale

In this step, position information indicating the position of the scales in the Y direction (medium width direction) in the image data is acquired based on the image data (pixel data) of the linear scale. First, the computer 110 calculates the average of the gray scale values of the pixel data of the pixels lined up in the X direction in the two-dimensional image data. Accordingly, one-dimensional image data in the Y direction is generated. This one-dimensional image data includes pixel data of the pixels lined up at 2880 dpi in the Y direction.

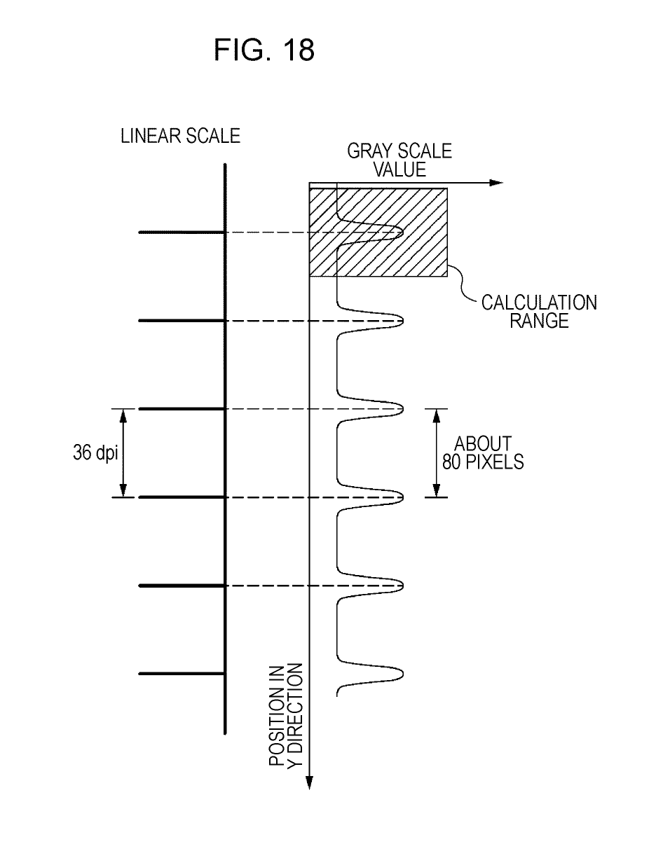

FIG. 18 is a graph illustrating the one-dimensional image data. In this graph, the horizontal axis represents a gray scale value and the vertical axis represents the position of pixels in the Y direction. The positions of the corresponding scales of the linear scale are shown on the left side of the graph. Since the linear scale with the scales formed at the interval of 36 dpi is read at the resolution of 2880 dpi, the peaks indicating the positions of the scales are shown on the graph at the interval of about 80 pixels.

The computer 110 obtains the pixel data of 80 pixels (range indicated by diagonal lines in FIG. 18) before and after the initial peak as a calculation range and normalizes data corresponding to the 80 pixels. The normalization is executed by calculating the sum of the gray scale values of 80 pixel data and dividing the gray scale values of the respective pixel data by the sum value. The central positions of the pixel data subjected to the normalization are calculated as the positions of the scales of the linear scale. The central positions of the pixel data can be obtained by multiplying the gray scale values of the respective pixels and the position in the Y direction and calculating the sum thereof. The calculated central positions are stored as the positions of the scales of the linear scale. The pixel data correspond to the integer positions in the Y direction, but the central positions are not necessarily the integer positions.

The computer 110 calculates all of the positions of the scales in the Y direction in the image data by repeatedly performing the above-described process, and acquires the position information indicating the corresponding positions. The subsequent calculation range is the pixel data corresponding to 80 pixels before and after centered on the position located 80 pixels away from the previously calculated central position. When there is no error in the positions read by the scanner 150, the interval of the positions of the calculated scales will be 80 (pixels). In effect, however, since there is an error in the read positions, the interval of the positions of the calculated scales may not be 80 (pixels) in some cases. In this case, the position information indicating the positions of the calculated scales is information on which the error in the positions read by the scanner 150 is reflected.

### S204: Correcting Image Data

Next, the image data of the test pattern is corrected based on the acquired position information. Then, the density correction value is acquired for each raster line based on the corrected image data.

The computer 110 first calculates a “density calculation position” based on the position information acquired in the above-described manner. The “density calculation position” indicates where the position of the actual 1/2880 inch interval (equal interval) is located on the image data of the test pattern. Since the positions of the scales calculated in S203 indicates where the position of the actual 36 dpi interval is located on the image data, the density calculated position is calculated by dividing the positions of the calculated scales by 80. That is, the density calculation position is calculated by interpolating the positions of 79 dots between two adjacent scales of the linear scale.

When there is no error in the position read by the scanner 150, the interval of the calculated density calculation position will be 1 (pixel). In effect, however, since there is an error in the read position, the interval of the calculated density calculation position is not 1 (pixel). In general, the density calculation position does not become an integer.

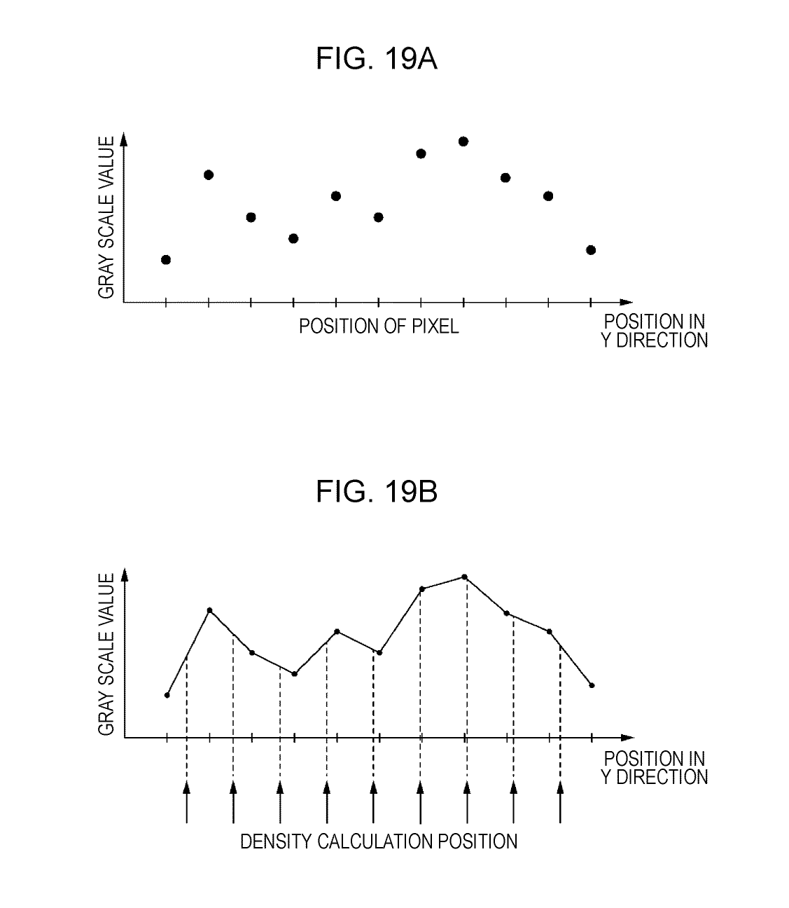

FIG. 19A is a diagram illustrating the image data of the test pattern before correction. In the drawing, the horizontal axis represents the positions of the pixels in the Y direction. The scales of the horizontal axis represent the integer positions in the Y direction and represent the corresponding positions of the respective pixels. In the drawing, the vertical axis represents the gray scale values indicated by the pixel data. Here, the gray scale values of the pixel data of the pixels lined up in the Y direction in the two-dimensional image data are indicated as discrete data by black circles.

FIG. 19B is a diagram illustrating a method of calculating the pixel data corresponding to the density calculation position. The position of each arrow in the drawing indicates the density calculation position. As described above, there is an error in the read positions. Therefore, the interval of the density calculation positions is not 1 and the density calculation position does not become an integer. The computer 110 calculates the gray scale value corresponding to the density calculation position by linear interpolation.

The image data of the test pattern is corrected by setting the gray scale value of a first density calculation position as the pixel data of a first pixel in the Y direction and setting the gray scale value of an n-th density calculation position as the pixel data of an n-th pixel in the Y direction. As a consequence, the distortion of an image of the corresponding image data in the Y direction (medium width direction) is corrected. That is, the raster lines on the printed test pattern can correspond to the raster lines on the image data read by the scanner.

Then, the computer 110 converts the resolution so that the image of the test pattern with 2880 dpi becomes an image with 720 dpi. Through the resolution conversion, the number of pixels lined up in the Y direction becomes the same as the number of raster lines forming the test pattern. As a consequence, the lines of the pixels lined up in the Y direction on the image data subjected to the resolution conversion correspond to the line areas. For example, the pixel line in the Y direction located at the first position corresponds to the first line area and the pixel line located below that pixel line corresponds to the second line area.

In other words, in this embodiment, the read density of the image data at the position in the Y direction which corresponds to each line area of the image data is obtained for each line area based on the position of the detected scale of the linear scale.

As the method of correcting the image data, the distortion in the Y direction can be corrected when performing the resolution conversion, as in the method used in S103.

In this embodiment, since the lower ruled line serving as a reference is not formed (the upper ruled line is formed), the lowermost scale of the linear scale is used instead of the lower ruled line.

For example, it is assumed that the lowermost scale of the printed linear scale is the tenth scale from the upper ruled line (upper reference position). In this case, the line of the tenth scale of the linear scale serves as the lower reference position. Since one scale of the linear scale corresponds to 80 pixels, the number of pixels between the upper ruled line and the lowermost scale of the linear scale will be 800 pixels (=80 pixels×10 scales) in theory. In effect, however, the number of pixels is 807 since there is the influence of the deviation in the printing or in the reading.

On the other hand, the resolution is 2880 dpi when the resolution is read by the scanner and the resolution is 720 dpi in the printing, the raster lines of the test pattern in the printing will be 200 lines (=800 pixels/(2880 dpi/720 dpi)).

Here, the resolution conversion (reduction process) is performed at a magnification ratio of 200/807 (=[number of raster lines forming the test pattern]/[number of pixels in the Y direction between the upper and lower ruled lines of the image data]). Thus, the number of pixels of the image data subjected to the resolution conversion in the Y direction is 200. As a consequence, since the number of pixels lined up in the Y direction becomes the same as the number of line areas, the line areas and the pixel lines in the X direction correspond to each other one to one.

### S205: Acquiring Gray Scale Value

### S206: Calculating Correction Value H

The read gray scale value is acquired for each line area in the corrected image data (S205) and the correction value H used to correct the gray scale value of the pixel line data corresponding to each line area is calculated (S206). The specific methods are the same as those described above (S104) and (S105).

The calculated correction value H is stored in the memory 63, and the density is corrected based on the correction value when a user executes printing. The density correction method is the same as that of the comparative example.

### Advantages of Embodiment

By using the test pattern in which the linear scale is printed, the exact density correction value can be acquired irrespective of the size of the print medium. For example, when the print medium is small, the entire test pattern may not be printed. Therefore, the exact correction value can be acquired without printing the lower ruled line serving as a reference in the correction of the distortion when the image data is read by a scanner or the like and is generated.

According to this embodiment, since the interval of the scales of the linear scale can be used as a reference in the correction of the image data, thereby coping with media with all sizes.

It is sufficient that only one kind of data for printing the test pattern according to this embodiment is prepared for the medium with the largest size, and it is not necessary to generate new data each time the size of the print medium is changed. The test pattern according to this embodiment is not greatly modified from the test pattern used in the related art, but has a simple structure in which only a linear scale is added to the test pattern of the related art. Thus, the print data for printing the test pattern is generated at a slight cost.

A ready-made linear scale is not used, but the linear scale is printed using the head (nozzles) printing the test pattern. When the ready-made linear scale is used, it is necessary to perform a process or the like of reading only the linear scale separately from the test pattern by a scanner or the like and performing separate correction. Therefore, a problem may arise in terms of work efficiency or cost. However, this problem is resolved by printing both the test pattern and the linear scale.

Moreover, by performing the printing using the same nozzles, it is easy to make the raster lines formed in the printing correspond to the pixel lines in the reading of the image. Even when the ink ejected from the nozzles flies in a curved manner, the image data can be corrected in consideration of the influence of the ink flying in the curved manner. Thus, the density irregularity or the like occurring due to a difference in the processing precision of the nozzles of each printer can be exactly corrected.

### Summary

According to this embodiment, the test pattern in which dot lines formed in the transport direction (X direction) of the medium are lined up in the medium width direction (Y direction) and the linear scale in which scales are lined up in the medium width direction are printed on the same medium. The printed test pattern is read by a scanner and is acquired as the image data.

Since the acquired image data contains an error occurring in the reading by the scanner, a deviation occurs between the pixel lines on the image data and the raster lines formed in the actual printing. Thus, the deviation of the image data is corrected by detecting the positions (in the Y direction) of the scales of the linear scale on the image data and calculating the gray scale values of the test pattern at the positions of the scales.

Thereafter, the read gray scale values for the pixel lines are calculated from the corrected image data. A variation in the read gray scale values occurs in the respective pixel lines, and thus the variation causes the density irregularity in the printed image. Thus, the density correction can be performed in the actual printing by calculating the correction value H used to reduce the variation in the read gray scale values in the respective pixel lines and storing the correction value H in the memory of the computer 110.

The image data is corrected by calculating the “density calculation positions” of the test patterns from the positions of the scales of the linear scale and calculating the pixel data corresponding to the density calculation positions. Specifically, the gray scale values at the density calculation positions are calculated by performing linear interpolation using the gray scale values of the pixels between two dots lined up in the Y direction between the density calculation positions for the data of the test patterns before correction. The image data of the test pattern is corrected by setting the gray scale value calculated at the n-th density calculation position as the n-th pixel data in the Y direction.

Since the raster lines on the printed test pattern can correspond to the raster lines on the image data read by the scanner, the exact correction values H can be calculated.

As the method of correcting the image data, there is a method of correcting the number of pixels interposed between the upper and lower reference lines of a test pattern when the resolution of the image data is converted as in the related art. In this embodiment, the entire test pattern may not be printed when the length of the medium in the width direction is small. Therefore, the lower ruled line serving as the lower reference position is not printed. Instead of the lower ruled line, the scales of the linear scale are used. The image data of the test pattern can be corrected by converting the resolution so that the number of pixel lines actually formed between the upper ruled line and the scales of the linear scale matches with the theoretical number of pixel lines.

Since the printer 1 according to this embodiment performs printing using the ink of four YMCK colors, the density correction is performed for each head ejecting each color ink. Here, the linear scale printed together with the test pattern is typically printed with black ink to easily view the positions of the scales, but each linear scale may be printed for each color of YMCK.

In this case, the heads forming the test patterns and the heads forming the linear scales correspond to each other one to one. Therefore, an image can be corrected with more precision compared to the case where the test patterns formed with other colors (CMY) are corrected using the linear scale formed with one color of black ink.

### Other Embodiments

The printer and the like according to an embodiment have hitherto been described. However, the above-described embodiment has been described in order to understand the invention with ease and is not construed to limit the invention. Of course, the invention can be modified and improved without departing the gist of the invention and include the equivalents thereof. In particular, the following embodiments are included in the invention.

### Printing Apparatus

In the above-described embodiment, the lateral scan-type printer 1 has been described as an example. However, the printer may be a so-called line printer in which a head is fixed, or may be a serial printer in which the head 41 is moved together with a carriage.

### Ink to be Used

In the above-described embodiment, the example in which the ink of four YMCK colors is used has been described, but the invention is not limited thereto. For example, ink such as light cyan, light magenta, white, and clear other than YMCK may be used to perform printing.

### Arrangement of Nozzle Lines

The nozzle lines of the head unit are lined up in arrangement order of YMCK from the upstream side in the transport direction, but the invention is not limited thereto. For example, the sequence of the nozzle lines may be exchanged, and the number of nozzle lines for K ink may be larger than the number of nozzle lines the other inks.

### Printer Driver

The process of the printer driver may be executed in the printer. In this case, the printer and a PC on which the printer driver is installed form a printing apparatus.

The entire disclosure of Japanese Patent Application No. 2010-068668, filed Mar. 24, 2010 is expressly incorporated by reference herein.

What is claimed is:

1. A correction value acquisition method comprising:
forming parts of a test pattern, in which dot lines formed in an intersection direction intersecting a predetermined direction are lined up in the predetermined direction, and a linear scale, in which scales are lined up in the predetermined direction, on a medium of which a length in the predetermined direction is shorter than a length of the test pattern in the predetermined direction using a liquid ejection recording apparatus forming dots on the medium by ejecting a liquid from nozzle lines lined up in the predetermined direction according to the print data used to form the test pattern and the linear scale;
detecting positions of the scales of the linear scale from image data obtained by reading the test pattern and the linear scale formed on the medium;
obtaining a read density of the image data for each of the dot lines at positions corresponding to the dot lines of the image data in the predetermined direction based on the detected positions of the scales; and
calculating a correction value corresponding to each of the dot lines based on the read density corresponding to each of the dot lines.

2. The correction value acquisition method according to claim 1, wherein the read density of the image data at each of the positions corresponding to the dot lines of the image data in the predetermined direction is obtained by segmenting a gap between two adjacent scales of the linear scale into the number of pixels, which is calculated by dividing a read resolution of the image data in the predetermined direction by an interval of the scales of the linear scale in the predetermined direction, and using gray scale values at positions corresponding to the segmented pixels in the predetermined direction in the image data.

3. The correction value acquisition method according to claim 1, wherein a resolution of the image data is converted so that the actual number of pixels formed between a ruled line printed together with the test pattern in the intersection direction and a predetermined scale among the scales of the linear scale matches with the number of dot lines formed in theory.

4. The correction value acquisition method according to claim 1, wherein the liquid ejection recording apparatus includes a plurality of nozzle lines ejecting a plurality of different color ink, respectively, and prints the linear scales with different colors and the test patterns for the nozzle lines, respectively.

5. A correction value acquisition program which is stored in a memory and acquires a correction value used when densities of dot lines formed in an intersection direction intersecting a predetermined direction with ink ejected from nozzle lines lined up in the predetermined direction are corrected, the correction value acquisition program comprising:
forming parts of a test pattern, in which dot lines formed in the intersection direction intersecting the predetermined direction are lined up in the predetermined direction, and a linear scale, in which scales are lined up in the predetermined direction, on a medium of which a length in the predetermined direction is shorter than a length of the test pattern in the predetermined direction according to the print data used to form the test pattern and the linear scale;
detecting positions of the scales of the linear scale from image data obtained by reading the test pattern and the linear scale formed on the medium;
obtaining a read density of the image data for each of the dot lines at positions corresponding to the dot lines of the image data in the predetermined direction based on the detected positions of the scales; and
calculating a correction value corresponding to each of the dot lines based on the read density corresponding to each of the dot lines.

6. The correction value acquisition program according to claim 5, wherein the read density of the image data at each of the positions corresponding to the dot lines of the image data in the predetermined direction is obtained by segmenting a gap between two adjacent scales of the linear scale into the number of pixels, which is calculated by dividing a read resolution of the image data in the predetermined direction by an interval of the scales of the linear scale in the predetermined direction, and using gray scale values at positions corresponding to the segmented pixels in the predetermined direction in the image data.

7. The correction value acquisition program according to claim 5, wherein the linear scales with different colors and the test patterns are printed for nozzle lines ejecting a plurality of different color ink, respectively.

8. A liquid ejection recording apparatus comprising:
a head unit including nozzle lines lined up in a predetermined direction and forming dots by ejecting a liquid on a medium; and
a controller controlling the head unit,
wherein the controller
forms parts of a test pattern, in which dot lines formed in an intersection direction intersecting the predetermined direction are lined up in the predetermined direction, and a linear scale, in which scales are lined up in the predetermined direction, on a medium of which a length in the predetermined direction is shorter than a length of the test pattern in the predetermined direction according to print data used to form the test pattern and the linear scale,
detects positions of the scales of the linear scale from image data obtained by reading the test pattern and the linear scale formed on the medium,
obtains a read density of the image data for each of the dot lines at positions corresponding to the dot lines of the image data in the predetermined direction based on the detected positions of the scales, and
calculates a correction value corresponding to each of the dot lines based on the read density corresponding to each of the dot lines.
